(19) United States
(12) Patent Application Publication
(10) Pub. No.: US 2012/0107471 A1
(43) Pub. Date: May 3, 2012

(54) Quick Frying Method Adapted for Using a Small Amount of Fatty Material and Apparatus Using Said Method

(75) Inventors: Celine Sobole, Clenay (FR); Jean-Marie Balandier, Bretigny (FR)

(73) Assignee: SEB S.A., Ecully (FR)

(21) Appl. No.: 13/266,403

(22) PCT Filed: Apr. 23, 2010
(86) PCT No.: PCT/FR2010/050782

§ 371 Date: Jan. 9, 2012

(30) Foreign Application Priority Data
Apr. 27, 2009 (FR) 0902025

(51) Int. Cl. A47J 37/12; A23L 1/01

(52) U.S. Cl. 426/438; 99/339

(57) ABSTRACT

Provided is a method for frying food that comprises mixing said food with a fatty material in a cooking housing in association with the ventilation of said cooking housing and the heating of said cooking housing heating means capable of heating by radiation. The method comprises limiting the exposure of the food to the radiation of the heating means during an initial food drying and cooking step, and increasing the exposure of the food to the radiation of the heating means during a following food colouring step. The cooking apparatus comprising a cooking housing associated with food mixing means, with heating means capable of heating by radiation and with ventilation means, and to means for modulating the exposure of the food to the radiation of the heating means.

This invention relates to the general technical domain of food cooking appliances.

This invention relates specifically to the technical domain of cooking appliances provided for frying food using a low quantity of fat. This invention relates particularly, but not exclusively, to domestic appliances.

A cooking appliance of the aforementioned type is known from document WO2006/000699 or from document WO2006/000700. This appliance has a cooking chamber associated with a heating device producing a flow of hot air sent to the interior of said cooking chamber. A disadvantage of the construction of this appliance rests, in any case, in the fact that the heating is localized. Notably, when frying is done using fresh potatoes, the localized heating leads to a recurrence of moisture in the pieces of food, which contributes to the necessity of a significant cooking time to dry the food sufficiently.

A cooking appliance using a heating device arranged in the cooking chamber is known from document WO89/10085. The heating of the cooking chamber is therefore more homogeneous. Nevertheless, this document does not mention specific performances concerning the quality or the rapidity of the cooking. Furthermore, this document does not consider the mixing of the food with the fat.

An aim of this invention is to propose a cooking process that makes it possible to obtain fried food more rapidly by using a lower quantity of fat than when cooking in an oil bath.

An aim of this invention is to propose a cooking process that makes it possible to obtain fried food more rapidly while preserving its organoleptic and nutritional qualities.

Another aim of this invention is to propose a cooking appliance that makes it possible to obtain fried food more rapidly by using a lower quantity of fat than when cooking in an oil bath.

Another aim of this invention is to propose a cooking appliance that makes it possible to obtain fried food more rapidly while preserving its organoleptic and nutritional qualities.

These aims are achieved with a food frying process using a mixture of said food with the fat in a cooking chamber, associated with ventilation of said cooking chamber and heating of said cooking chamber using heating means suitable for heating by radiant heat, said process consisting in limiting the exposure of the food to the radiant heat of the heating means during an initial drying and cooking stage of the food and exposing the food to the radiant heat of the heating means at a later stage for coloring the food. This provision makes it possible to optimize the cooking rate while obtaining a good cooking quality. The limitation of the exposure of the food to the radiant heat of the heating means during the initial drying and cooking stage of the food makes it possible to preserve a sufficient temperature in the cooking chamber to evaporate the water contained in the food and dry its surface, without reaching a temperature sufficient to trigger the Maillard reaction. The evacuation of the moisture contained in the food contributes to the maintenance of a relatively moderate temperature inside the cooking chamber during this initial stage. The gelatinization of the starch makes the potatoes edible during this initial stage. The drying of the surface of the food promotes the progress of the Maillard reaction and makes it possible to improve the mechanical integrity of the food, particularly potatoes cut into sticks to make the fries, while hardening their surface. Thus the shape of the food can be preserved. The drying being located preferably on the edges, the coloration also being done on the edges, this makes it possible to obtain a good visual quality for fries made from fresh potatoes. When the food has been dried, the use of a significant ventilation speed is no longer necessary for the later food coloration stage. Thus very short cooking times can be obtained even with fresh potatoes. The extensive drying during the first phase allows better preservation of the geometry of the fries and also the use of lower temperatures during the second phase.

According to an advantageous embodiment, the limitation of the exposure of the food to the radiant heat of the heating means during the initial drying and cooking stage of the food is achieved by limiting the radiant heat of the heating means. If desired, different heating means may be used for the initial drying and cooking stage of the food and for the later food coloration stage, for example, a first heating element for the initial drying and cooking stage of the food; this first heating element being completed or replaced by a second heating element for the later food coloration stage.

Advantageously then, the limitation of the radiant heat of the heating means during the initial drying and cooking stage of the food is achieved by ventilating the heating means. The ventilation of the heating means makes it possible to limit the temperature of the heating means and reduce its radiant heat.

Advantageously then, the transition from the initial drying and cooking stage of the food to the later food coloration stage is achieved by reducing the ventilation of the heating means. If desired, the ventilation of the heating means can be halted at least temporarily during the later food coloration stage. However, the pursuit of the ventilation of the cooking chamber can promote the homogenization of the temperature inside the cooking chamber.

Advantageously then, to promote the Maillard reaction, the temperature in the cooking chamber is greater than 150° C. during the later food coloration stage.

According to a preferred embodiment, particularly for a domestic appliance, during the initial drying and cooking stage of the food the air speed for the food is greater than 1.5 m/s, and preferably greater than 2 m/s.

According to a preferred embodiment, particularly for a domestic appliance, during the later food coloration stage the air speed for the food is less than 1.5 m/s, and preferably less than 1 m/s.

According to a preferred embodiment, the air speed of the food is reduced at least 20% between the initial drying and cooking stage of the food and the later food coloration stage.

These aims are also achieved with a cooking appliance comprising a cooking chamber associated with the means of mixing food including a receptacle suitable to contain the fat, the heating means suitable to heat by radiant heat, and the ventilation means. In view of the fact that the heating means is arranged in the cooking chamber and that said appliance includes the means to adjust the exposure of the food to the radiant heat of the heating means, said means is suitable to limit the exposure of the food to the radiant heat of the heating means during a initial drying and cooking stage of the food and to expose the food to the radiant heat of the heating means during a later food coloration stage. The appliance thus proposed makes it possible to do the frying more rapidly with a low quantity of oil, due to better drying of the food during the initial stage, while preserving the organoleptic and nutritional qualities, particularly because the appliance thus proposed makes it possible to do the frying more rapidly using a low quantity of oil and with the coloration occurring during the later stage.

According to an embodiment, the means to adjust the exposure of the food to the radiant heat of the heating means includes a control device provided to regulate the rotation rate of a ventilation motor belonging to the means of ventilation. Alternatively, the means to adjust the exposure of the food to the radiant heat of the heating means may specifically include the means to adjust the power of the heating means, the means to select the power supply of one or more heating elements and a screen suitable for adjusting the exposure of the food to the radiant heat of the heating means.

Advantageously then, the receptacle rotates according to an inclined axis. This provision makes it possible to obtain a proper homogeneity of the coloration of the fried food.

Advantageously then, the receptacle forms a vessel. This provision makes it possible to obtain the fried food from raw food and fat, particularly with a smaller quantity of fat.

Advantageously then, an agitation body extends into the interior of the receptacle. This provision makes it possible to obtain better homogeneity of cooking while promoting the mixing of the food.

Advantageously then, the agitation body rotates with the receptacle. This provision promotes better preservation of the geometry of the fried food.

Advantageously again, the proposed cooking appliance is suitable for the implementation of the aforementioned rapid frying process.

Advantageously again, the means to adjust the exposure of the food to the radiant heat of the heating means is provided for the implementation of the aforementioned food frying process.

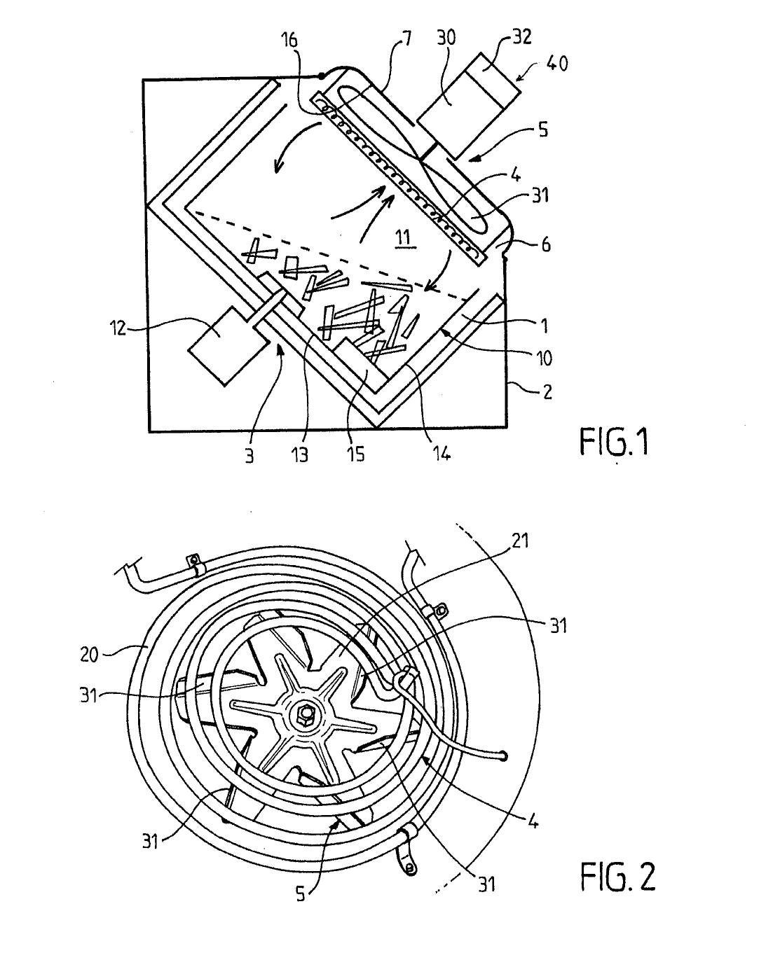

The invention will be better understood by the study of a non-exhaustive embodiment example, illustrated in the attached FIGS. 1 and 2, in which:

FIG. 1 is a cross-section of a schematic lateral view of a cooking appliance according to the invention,

FIG. 2 is a perspectival view below the heating device and the ventilation device.

The appliance illustrated in FIG. 1 is comprised of a cooking chamber 1 housed in a casing 2. The cooking chamber 1 is associated with the means of mixing the food 3, the heating means 4 suitable for heating by radiant heat as well as the ventilation means 5. As is visible indeed in FIG. 1, the heating means 4 are arranged in the cooking chamber 1. The casing 2 has an access opening 6 provided for the introduction of the food into the cooking chamber 1. The access opening 6 is advantageously closed by a cover 7. The cover 7 is, for example, pivotally mounted on the casing 2.

The means of mixing food 3 includes a receptacle 10 housed in the cooking chamber 1. The receptacle 10 has an opening 11. The receptacle 10 is preferably arranged at a distance from the inner walls of the cooking chamber 1, particularly to avoid the loss of energy to the exterior and to optimize the power of the heating means 4. The receptacle 10 is rotated according to an inclined axis by a drive motor 12. The rotation rate of the receptacle 10 is, for example, on the order of 24 turns/min. The angle of inclination of the axis of rotation of the receptacle 10 in relation to the vertical ranges advantageously between 20° and 50° and preferably between 33° and 45°.

In order to make the fries from fresh potatoes and a reduced quantity of fat, for example, 14 ml for 1 kg of fresh potatoes, the receptacle 10 has preferably a solid bottom 13 prolonged by a solid side wall 14. Thus the receptacle 10 forms a vessel. The receptacle 10 thus can contain the fat as a result of the coating of the food during the rotation of said receptacle 10. The receptacle 10 can also be used to fry or brown the food in a greater quantity of oil. According to the embodiment example illustrated in FIG. 1, the opening 11 is defined by the upper edge of the solid side wall 14.

An agitation body 15 extending into the interior of the receptacle 10 is provided to draw in at least part of the pieces of food during the rotation of the receptacle 10. The agitation body is rotated with the receptacle 10. Specifically, the agitation body 15 is fixed in the receptacle 10 during the rotation of the receptacle 10. The food repulsed by the agitation body 15 falls back into the receptacle 10 while moving the one in relation to the other. The agitation body 15 thus makes it possible to mix the food during the rotation of the receptacle 10.

The heating means 4 is arranged inside the cooking chamber 1 with regard to the opening 11 of the receptacle 10. Thus the heating of the cooking chamber 1 is done in a relatively homogeneous manner, particularly the surface of the food arranged in the receptacle 10. The heating means 4 arranged inside the cooking chamber 1 makes it possible to heat the cooking chamber 1 better overall and to avoid the recurrence of moisture. For a quantity of food to be fried, corresponding to 1 kg of fresh potatoes or 750 g of deep-frozen, precooked potatoes, the power of the heating means 4, for example, ranges between 2000 W and 3000 W.

As is more visible in FIG. 2, the heating means 4 is advantageously shaped by a reinforced heating element 20. The reinforced heating element 20 has advantageously an annular configuration producing a central zone 21. The reinforced heating element 20, for example, is wound in a spiral around the central zone 21. The heating means 4 is advantageously mounted under a cup 16. The cup 16, for example, is shaped by the inner face of the cover 7 or mounted on the inner face of the cover 7. The cup 16 can have a inner face made of material acting as a reflector.

The ventilation means 5 includes a ventilation motor 30 advantageously arranged on the exterior of the cooking chamber 1 as well as the ventilation bodies 31 driven by the ventilation motor 30. The ventilation bodies 31 are arranged inside the cooking chamber 1 with regard to the opening 11 of the receptacle 10. The ventilation bodies 31 are advantageously mounted between the cup 16 and the heating means 4. Specifically, the ventilation bodies 31 are provided to direct a flow of air onto the heating means 4. To this end, the aspiration zone of the ventilation bodies 31 corresponds advantageously to the central zone 21.

Thus the ventilation bodies 31 form a centrifugal blower. The cup 16 has advantageously a curved peripheral part provided to direct the flow of hot air with regard to the opening 11 of the receptacle 10.

The ventilation means 5 is associated with a control device 32 provided to regulate the rotation rate of the ventilation motor 30, for example, with an elevated speed and a lower speed. When the rotation rate of the ventilation motor 30 is elevated, for example, on the order of 3000 turns/min, the flow of air propelled by the ventilation bodies 31 makes it possible to limit the temperature of the heating means 4. The radiant heat of the heating means occurs at a temperature level of 150° C. in the cooking chamber 1 of the heating means 4 while the reinforced heating element 20 and the flow of air propelled by the ventilation bodies 31 make it possible to limit the radiant heat of the heating means 4. When the rotation rate of the ventilation motor 30 is lower, for example, on the order of 1500 turns/min, the cooling of the heating means 4 is less significant, and the flow of air propelled by the ventilation bodies 31 no longer makes it possible to limit the radiant heat of the heating means 4 as much.

This invention is used and functions in the following manner.

The user places the desired quantity of food in the receptacle 10, for example, 1 kg of fresh potatoes with 14 ml of oil, or even 750 g of deep-frozen, precooked potatoes. The user then closes the cover 7 and switches on the appliance. The receptacle 10 is then driven by the drive motor 12; the ventilation bodies 31 are then driven by the ventilation motor 30; and the cooking chamber 1 is heated by the heating means 4. During the rotation of the receptacle 10 the agitation body 15 raises at least part of the pieces of food periodically and allows the mixing of the food present in the receptacle 10.

During a first drying and cooking phase of the food, the rotation rate of the ventilation motor 30 is elevated, for example, on the order of 3000 turns/min. The flow of air propelled by the ventilation bodies 31 makes it possible to limit the radiant heat of the heating means 4, homogenizing the temperature inside the cooking chamber 1, and drying the food present in the cooking chamber 1, while ensuring the cooking of said food. The agitation of the pieces of food by the agitation body 15 makes it possible to obtain a better homogeneity when drying the different pieces of food. The duration of the first drying and cooking phase of the food, for example, is 8 min for the fries made from 1 kg of fresh potatoes and 14 ml of oil.

During a second food coloration phase, the rotation rate of the ventilation motor 30 is less elevated, for example, on the order of 1500 turns/min. The flow of air propelled by the ventilation bodies 31 is insufficient to prevent the radiant heat of the heating means 4. The radiant heat of the heating means 4 associated with the elevated temperature in the cooking chamber, preferably greater than 150° C., makes it possible to develop the Maillard reaction and to color the food present in the cooking chamber 1. The agitation of the pieces of food by the agitation body 15 allows a better homogeneity of the coloration of the different pieces of food. The duration of the second phase of drying and cooking phase of the food, for example, is 12 min for the fries made from 1 kg of fresh potatoes and 14 ml of oil.

The proposed appliance thus implements a food frying process using a mixing of said food in the cooking chamber 1, associated with ventilation of said cooking chamber 1 and heating of said cooking chamber 1 using the heating means 4 suitable to heating by radiant heat. This process is intended to limit the exposure of the food to the radiant heat of the heating means 4 during an initial drying and cooking stage of the food and to expose the food to the radiant heat of the heating means 4 during a later food coloration stage. The quantity of fat used is lower than that for cooking in an oil bath.

Thus the appliance includes the means 40 to adjust the exposure of the food to the radiant heat of the heating means 4, said means being provided for the implementation of said process of frying food.

In the embodiment example described, the means 40 to adjust the exposure of the food to the radiant heat of the heating means 4 includes the control device 32 provided to regulate the rotation rate of the ventilation motor 30 belonging to the ventilation means 5.

In the embodiment example described, the limitation of the exposure of the food to the radiant heat of the heating means 4 during the initial drying and cooking stage of the food is obtained by limiting the radiant heat of the heating means 4.

As a variant, different heating means can be used for the initial drying and cooking stage of the food and for the later food coloration stage.

Other arrangements making it possible to limit the radiant heat of the heating means; in particular, the supply of the heating means on at least two power levels, can also be considered.

In the embodiment example described, the limitation of the radiant heat of the heating means 4 during the initial drying and cooking stage of the food is achieved by ventilating the heating means 4. However, other arrangements making it possible to limit the radiant heat of the means, particularly, the supply of the heating means on at least two power levels or the use of different heating means can be considered.

In the embodiment example described, the transition from the initial drying and cooking stage of the food to the later food coloration stage is achieved by reducing the ventilation of the heating means 4.

As a variant, the ventilation of the heating means 4 can be halted at least temporarily during the later food coloration stage. However, the pursuit of the ventilation of the cooking chamber makes it possible to promote the homogenization of the temperature inside the cooking chamber.

The temperature in the cooking chamber, greater than 150° C. during the later food coloration stage, makes it possible to develop the Maillard reaction. If desired, the temperature in the cooking chamber can be greater than 200° C. during the later food coloration stage.

According to a preferred embodiment, particularly for a domestic appliance, during the initial drying and cooking stage of the food, the air speed over the food is greater than 1.5 m/s, and preferably greater than 2 m/s.

According to a preferred embodiment, particularly for a domestic appliance, during the later food coloration stage, the air speed over the food is less than 1.5 m/s, and preferably less than 1 m/s.

According to a preferred embodiment, the air speed over the food is reduced at least 20% between the initial drying and cooking stage of the food and the later food coloration stage.

To make the fries from fresh potatoes, the process uses a mixing of the food with the fat in the receptacle 10 arranged in the cooking chamber 1.

Thus fries with a low level of fat can be obtained in 17 to 22 min with the aforementioned process from 1 kg of fresh potatoes and 14 ml of oil, depending on the potato variety used.

In addition, the fries can be obtained in 15 min with the aforementioned process from 750 g of deep-frozen, precooked potatoes, without adding fat, or with a minimum addition of fat to improve the crispness.

If desired, several rotation rates of the receptacle 10 and/or several heating performance levels of the heating means 4 can be considered, particularly using the geometry of the food to be fried and/or the size of the food to be fried and/or the nature of the food to be fried (fresh food or deep-frozen, precooked food). The adjustment of the rotation rate of the ventilation bodies 31 and/or the duration of the initial drying and cooking stage of the food and/or the later food coloration stage can also be considered, in particular using the geometry of the food to be fried, and/or the size of the food to be fried and/or the nature of the food to be fried.

This invention makes it possible to obtain fries from 1 kg of fresh cut potatoes and 14 ml of oil in 20 min. This is more rapid than with a fryer in an oil bath from a cold start and with a cooking appliance such as that described in the documents WO 2006/000699 or WO2006/000700. Furthermore, the fries thus obtained are crisp with a shape that is well preserved. The organoleptic quality is comparable to that of fries obtained in a cooking appliance such as that described in the documents WO 2006/000699 or WO2006/000700, due to the use of a reduced quantity of fat.

The use of a chamber forming a vessel also makes it possible to fry in a greater quantity of oil while stirring the food.

As a variant, the heating means 4 is not necessarily shaped by the reinforced heating element 20.

As a variant, the heating means 4 can include several heating elements, for example, a first heating element used for the initial drying and cooking stage of the food, this first heating element being completed or replaced by a second heating element for the later food coloration stage. The means 40 to adjust the exposure of the food to the radiant heat of the heating means 4 includes then the means to select from the supply of one or more heating elements.

As a variant, the heating means 4 can be supplied with variable power. The means 40 to adjust the exposure of the food to the radiant heat of the heating means 4 includes then the means to adjust the power of the heating means 4.

As a variant, the heating means 4 can be associated with a screen likely to occupy at least a first configuration in which the exposure of the food to the radiant heat of the heating means 4 is reduced and a second configuration in which the exposure of the food to the radiant heat of the heating means 4 is greater than that in the first configuration. The screen, for example, can be located between the heating means 4 and the food, to hide more or less the radiant heat of the heating means 4, or again, be arranged at least partially in the flow of air from the ventilation means 5 to divert more or less the flow of air outside the ventilation means 5. The means 40 to adjust the exposure of the food to the radiant heat of the heating means 4 includes then the means to adjust the configuration of the screen.

As a variant, the mixing of the food in the receptacle 10 does not necessarily use an agitation body fixed in relation to the receptacle 10 but could be obtained specifically by using a movable paddle in relation to said chamber, the paddle and/or the chamber driven in rotation.

As a variant, the receptacle 10 is suitable to contain the fat and the food, but does not necessarily have a solid bottom 13 prolonged by a solid side wall 14. The side wall 14 in particular can be perforated in its upper section near the opening 11.

This invention is in no way limited to the embodiment example described and to its variants, but encompasses numerous modifications as a part of the claims.

1. A process for frying food using a mixing of said food with the fat in a cooking chamber, associated with ventilation of said cooking chamber and heating of said cooking chamber using heating means suitable for heating by radiant heat, wherein it limits the exposure of the food to the radiant heat of the heating means during an initial drying and cooking stage of the food and exposes the food to the radiant heat of the heating means during a later food coloration stage.

2. The process of frying food according to claim 1, wherein the limitation of the exposure of the food to the radiant heat of the heating means during the initial drying and cooking stage of the food is achieved by limiting the radiant heat of the heating means.

3. The process of frying food according to claim 2, wherein the limitation of the radiant heat of the heating means during the initial drying and cooking stage of the food is achieved by ventilating the heating means.

4. The process of frying food according to claim 3, wherein the transition from the initial drying and cooking stage of the food to the later food coloration stage is achieved by reducing the ventilation of the heating means.

5. The process of frying food according to claim 1, wherein the temperature in the cooking chamber is greater than 150° C. during the later food coloration stage.

6. The process of frying food according to claim 1, wherein during the initial drying and cooking stage of the food, the air speed over the food is greater than 1.5 m/s.

7. The process of frying food according to claim 1, wherein during the later food coloration stage the air speed over the food is less than 1.5 m/s.

8. The process of frying food according to claim 1, wherein the air speed over the food is reduced at least 20% between the initial drying and cooking stage of the food and the later food coloration stage.

9. A cooking appliance comprising a cooking chamber associated with the means of mixing of food, including a receptacle suitable for containing the fat, the heating means suitable for heating by radiant heat and the ventilation means, wherein the heating means is arranged in the cooking chamber, and wherein said appliance includes means to adjust the exposure of the food to the radiant heat of the heating means, said means being suitable for limiting the exposure of the food to the radiant heat of the heating means during the initial drying and cooking stage of the food and to exposing the food to the radiant heat of the heating means during a later food coloration stage.

10. The cooking appliance according to claim 9, wherein the means to adjust the exposure of the food to the radiant heat of the heating means includes a control device provided to regulate the rotation rate of a ventilation motor belonging to the ventilation means.

11. The cooking appliance according to claim 9, wherein the receptacle is rotated according to an inclined axis.

12. The cooking appliance according to claim 9, wherein the receptacle forms a vessel.

13. The cooking appliance according to claim 9, wherein an agitation body extends inside the receptacle.

14. The cooking appliance according to claim 13, wherein the agitation body is rotated with the receptacle.

15. The cooking appliance according to claim 9, wherein the means to adjust the exposure of the food to the radiant heat of the heating means is provided for the implementation of the process of frying food according to claim 1.

16. The process of frying food according to claim 1, wherein during the initial drying and cooking stage of the food the air speed over the food is greater than 2 m/s.

17. The process of frying food according to claim 1, wherein during the later food coloration stage the air speed over the food is less than 1 m/s.
